(19) United States
(12) Patent Application Publication
(10) Pub. No.: US 2026/0260493 A1
(43) Pub. Date: Sep. 3, 2026

(54) DEPTH CAMERA AND INDOOR LOCATION BEACON DATA CROSS-POLLINATION FOR USER PROFILE BUILDING

(71) Applicant: Dell Products L.P., Round Rock, TX (US)

(72) Inventors: Michael Robillard, Shrewsbury, MA (US); Yichun Xu, Everett, MA (US); Xuebin He, Westwood, MA (US); Rushiv Arora, Boston, MA (US); Ahmed Elsayed Elshafey, New Cairo (EG)

(21) Appl. No.: 19/066,314

(22) Filed: Feb. 28, 2025

(51) Int. Cl. G06V 20/52; G06T 7/20; G06T 7/70; G06V 10/764; G06V 40/16

(52) U.S. Cl. CPC G06V 20/52; G06T 7/20; G06T 7/70; G06V 10/764; G06V 40/178

(57) ABSTRACT

Generating user profiles by cross-pollinating data from sensors. Sensors, including radio beacons and depth-cameras, are deployed in an environment. The radio beacons collect positions of devices in the environment and the depth-cameras collect positions and demographics of users in the environments. The data from the radio beacons and depth-cameras are combined to generate user profiles that reflect routes of users in the environments. The user profiles may be used to at least improve operations, generate personalized recommendations, and perform security operations.

### TECHNOLOGICAL FIELD OF THE DISCLOSURE

Embodiments disclosed herein generally relate to immersive technologies and/or spatial computing. More particularly, at least some embodiments relate to systems, hardware, software, computer-readable media, and methods for building user profiles.

### BACKGROUND

Immersive technology often refers to technologies that are focused on real-world and/or virtual environments. Immersive technology allows users to interact with data persisted in datastores, machinery represented as digital twins, and artificial intelligence. Immersive technology is also related to spatial computing, which relates at least to interactions between digital and physical environments.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of an environment that includes sensors for building user profiles;

FIG. 2A-2B discloses aspects of determining a location of a user based on radio signals such as ultra-wide band signals in two dimensional space;

FIG. 3 discloses aspects of building user profiles based on data collected from a physical environment; and

FIG. 4 discloses aspects of a computing device, system, or entity.

### DETAILED DESCRIPTION OF SOME EXAMPLE EMBODIMENTS

Embodiments disclosed herein generally relate to building immersive technologies and/or spatial computing. More particularly, at least some embodiments relate to systems, hardware, software, computer-readable media, and methods for modeling and improving operations within spatial and/or immersive environments.

Embodiments of the invention relate to immersive technologies configured to transform or improve operations within spatial, digital, and/or immersive environments. In one example, a simulated environment may be generated that may operate with data collected from the physical environment. The simulated environment allows user profiles to be constructed that can be used to benefit the users in a physical environment.

The simulated environment may take various forms and may or may not be governed by real-world physics. The simulated environment may be configured to track real-time operations, which may include user-interactions, replay past or historical operations, perform historical analysis, perform exploratory planning, introduce new products, or the like or combinations thereof. The simulated environment may use data collected from or related to a physical environment, use machine learning models (e.g., generative artificial intelligence (GenAI)) to make predictions based on the collected data (e.g., most recent collected data input to a machine learning model trained on historical data), and the like.

Embodiments of the invention are discussed with respect to a retail environment, but may be implemented in other types of environments including manufacturing environments, warehouse environments, sporting environments, outdoor environments, or the like. Generally, the retail industry is faced with a variety of challenges including rapidly changing customer preferences, technological advancements, and increasing competition. The ability of a retailer to stay relevant may include finding ways to engage customers, reduce transactional friction, enhance shopping experiences, drive business transformation, and the like.

For example, immersive technologies aimed at addressing these challenges include produce visualization, virtual try-on, consumer privacy, interactive kiosks, and the like. These technologies help retailers cater to the demands of technologically adept consumers that may seek convenient, immersive, and informative retail experiences.

Embodiments of the invention address these issues, in part, by collecting data from various sources (e.g., sensors such as beacons, cameras) and cross pollinating the collected data to improve user profiles, which may be anonymized, permission based, or the like. For example, a retailor may be associated with an application that a user may install on their personal device (e.g., smart phone). When permissions are enabled, collected data from the user in a physical space may be used to build or improve a profile that enhances the retail experience of the user in a physical space. Even without an installed application, data collected from users anonymously can also be used to improve retail experiences, improve user profiles, and the like.

Embodiments of the invention further relate to generating data network effects. By way of example, a data network effect increases the value and utility of a system as data is accumulated. Embodiments of the network capture and process contextualized data automatically to generate a data network effect.

In some instances, the ability of GenAI to produce accurate responses may depend on the data network effect. More specifically, GenAI systems use large datasets that are refreshed in light of user interactions in an environment. The value of the Gen AI system depends on data that is automatically collected from users or user interactions and the performance of the Gen AI depends on the data network effect.

Data can be collected from a variety of sources. Example data sources may include interactions with buyers, suppliers, customers, and coworkers. A retailer, for example, may track what consumers look at, what products were placed in a cart, and what products were actually purchased. Data reflecting these interactions can improve the predictions or responses of a GenAI system.

Embodiments of the invention thus relate to operations, infrastructure, and systems configured to generate data network effects to improve the predictions and performance of GenAI systems. Embodiments of the invention may include obtaining geolocation data securely, accurately, and/or sustainably. Embodiments of the invention may further include beacon and/or camera tracking to generate recommendation systems that cater to users, based on user profiles in one example, in an anonymous manner.

Providing or improving personalized experiences to customers in physical environments is difficult, particularly when compared to online shopping experiences. One reason is that personalized information is difficult to collect in an offline scenario, such as a physical store. Embodiments of the invention address this concern by collecting data using sensors or sources such as indoor positioning systems (IPSs) (e.g., that include radio beacons), depth-capable cameras, and the like. These technologies allow demographic information to be collected and facilitate personalized or more-personalized in-person retail experiences. Embodiments of the invention collect data, anonymously in one example, that can be used to build user profiles.

In one example, data collected by an IPS and data collected form cameras may be used to track users in an environment. More specifically, the IPS may be configured to collect or derive information from smart devices carried by users or other appropriately configured devices. Depth cameras may be configured to recognize users, determine demographic data, and/or track movements or locations of users in the environment. The data collected from these systems are combined or linked to build improved user profiles, improve personalized interactions, generate data network effects, improve the retail experience holistically, or the like.

Embodiments of the invention relate to creating and/or managing an endless aisle, which may include offline and/or online aspects. In one example, an endless aisle is based on cameras (e.g., stereoscopic cameras), smart shelves, artificial intelligence models, radio beacons including ultra-wide band beacons, applications (e.g., device applications or apps), computing systems and displays, and the like or combinations thereof.

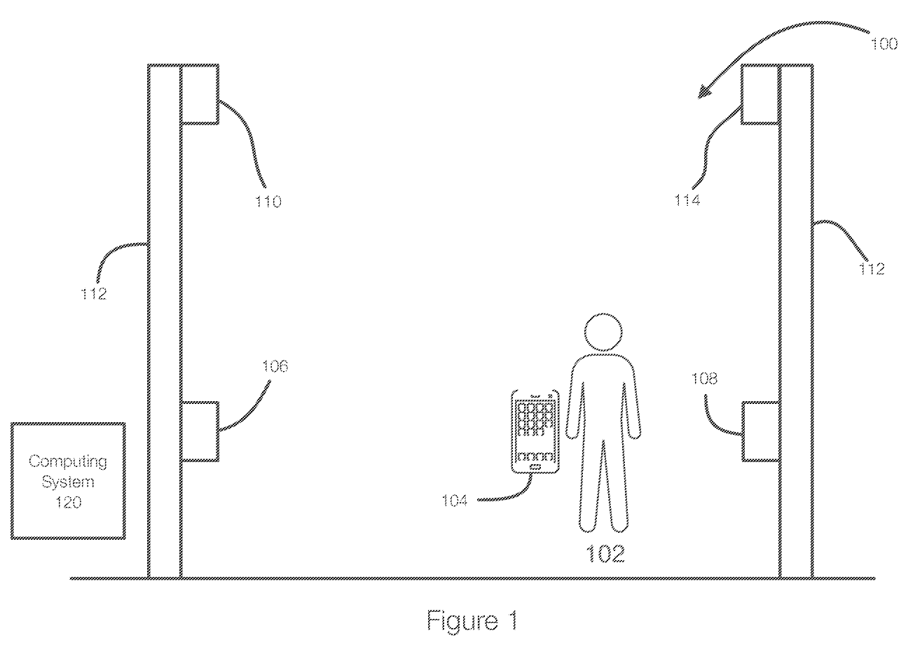

FIG. 1 discloses aspects of building user profiles based on data from multiple sensors or sources. FIG. 1 illustrates an environment 100. An example of the environment 100 is a retail environment, a warehouse environment, an outdoor environment, or the like or combinations thereof. In this example, the environment 100 includes cameras, represented by the camera 110 and the camera 114. The cameras 110 and 114 may be depth cameras configured to determine a distance to a user (e.g., a user 102) and a position (e.g., an angle/distance) of the user with respect to the camera. The cameras can detect and track positions or movement of users in the environment 100. In one example, the cameras 110 and 114 may be associated with a model configured to detect objects as humans. Objects, more specifically, may be classified by a trained model. Once an object is classified as human (e.g., a user), the position of the user can be determined and/or tracked.

Radio beacons (e.g., ultra-wide band (UWB)) beacons, represented by the beacons 106 and 108, are placed or positioned in the environment 100. The beacons 106 and 108 may be able to detect devices in the environment, such as the device 104 (e.g., a smartphone), as long as the devices are compatible with UWB. The device 104 is being carried by the user 102 in this example. As a result, the location or movement of the device 104 can be tracked using the beacons 106 and 108.

Because users in the environment 100 may move in/out of the ranges of specific beacons/cameras, combining the data collected by the beacons 106 and 108 and the data collected from the cameras 110 and 114 allow the movement of specific users to be determined. In one example, this allows route data to be combined such that the routes of specific users within the environment 100 can be determined. More specifically, the route of a particular device, as detected from multiple beacons, may be matched with routes of users tracked by various cameras. As a result, the route of a user or device in the environment 100 as a whole can be determined. Embodiments of the invention simplify the process of associating location data to specific users in the environment.

The cameras 110 and 114 and the beacons 106 and 108 are connected to a computing system 120. The system 120 may be on-premise, edge-based, cloud-based or the like or combinations thereof and may include processors, memory, networking hardware and the like. In one example, the cameras 110 and 114 and the beacons 106 and 108 may be configured to transmit data (e.g., environment data collected from the environment 100) to the system 120.

In one example, the system 120 may be configured to combine data from the cameras 110 and 114 with data from the beacons 106 and 108. More specifically, the beacons 106 and 108 may be used to detect and/or track a device 104 in the environment. Thus, the beacons 106 and 108 allow the system 120 to determine device identifiers (e.g., an identifier of the device 104) and locations of the device 104 in the environment 100. Data from the cameras 110 and 114 may be used to determine characteristics (e.g., demographic data) of the user 102 such height, gender, and the like and location data.

The system 120 can combine the camera data and the beacon data to obtain a more accurate understanding of a specific user. In some examples, this data is anonymous and privacy of the user 102 is protected. In one example, facial recognition is not performed.

In the environment 100, the cameras 110 and 114 are typically mounted at a high location (e.g., a ceiling) such that the cameras 110 and 114 have a clear view that is not blocked by obstacles (e.g., shelves, other users). The beacons 106 and 108, however, are typically mounted lower (e.g., user level). The beacons 106 and 108 are mounted in a plane or at a height that corresponds to a height at which the device 104 is carried (or anticipated to be carried). The locations of the cameras 110 and 114 and of the beacons 106 and 108 is disclosed by way of example and not limitation.

More specifically, embodiments of the invention arrange and configure the cameras 110 and 1114 and the beacons 106 and 108 such that the collected data can be handled from a two-dimensional perspective. My mounting the beacons 106 and 108 at an anticipated device height, (e.g., 3 ft high, between 2 and 4 feet, between 1 and 5 feet), devices in the environment 100 can be tracked in an x-y plane. This allows the system 120 to consider two dimensional direction or space rather than three dimensional directions or space. Data from the camera can easily be converted to (x,y) values corresponding to the map of the beacons 106 and 108.

In one example, user geolocation data is obtained using UWB beacons combined with depth camera data. UWB (Ultra-Wideband) technology may be used for near-location tracking at least because UWB receivers (e.g., the beacons 106 and 108) are positioned throughout the environment 100 to track UWB-enabled devices with high accuracy. The user devices emit UWB signal and the beacons 106 and 108 in in the environment 100 receive UWB signals from multiple device and then detect the locations of the devices. The cameras 110 and 114 detect users in the space and collect data about the users, which may include position or geolocation data, user demographic data, or the like.

As previously stated, the beacons 106 and 108 may be deployed or positioned at about the same height as devices such as smartphones. Deploying the beacons 106 and 108 in this manner eliminates the need to consider three-dimensional positions during location calculations and only two-dimensional calculations are required.

In one example, the camera 110 and the beacon 106 are deployed as a pair (the beacon 108 and the camera 114 may also be a pair). Thus, the camera 110 and the beacon 106 share the same location (e.g., (x,y) position). The (x.y) coordinates may be identical or within a threshold. The (x,y) coordinates can be treated to be the same even if not identical in one example. Because the beacons 106 and 108 are mounted in the same (or substantially the same plane) as the device 104, calculations can be performed from a two dimension perspective for at least the beacons 106 and 108.

In one example, the cameras 110 and 114 are turned on only after the corresponding beacon detects UWB signal. This may conserve computation workload from constant image analysis. In this example, embodiments of the invention allow computation capabilities of the system 120 to be controlled.

In one example, during setup, the sensor pairs (e.g., camera 110 and the beacon 106) are calibrated such that the same geometric map can be used for relative locations. The camera 110 and the beacon 106 are configured to be pointing in the same direction in one example. When the user 102 is detected, the camera 110 may send a message to the system 120 to report the location of the user 102. The image may be analyzed to determine demographic data. If a UWB signal is detected by the beacon 106, the beacon 106 may similarly send a message to the system 120 to report the location of the device 104.

The messages received by the system 120 may be saved to a live database. The system 120 may build histories, which may be limited in time, of user routes and device routes in the environment 100. This allows user routes to be compared to and matched to device routes. When a match is determined, the system 120 may perform image recognition on the camera data to collect information such as age, gender, height to the extent possible. However, facial information may not be captured or retained in order to protect user privacy.

The route information may be stored for subsequent analysis. For example, the route information may indicate that users spend a significant amount of time at a specific location (e.g., aisle 6). This may allow a retailer to adjust their retail strategies (e.g., stock more inventory, sell additional product similar to what is sold at that location).

The system 120 may attach the route information or insights gained from the route information to the device 104, to the user’s application, or the like. This may allow for personalized recommendations. The ability to cross pollinate data may also allow personalization to be performed in near real-time for users. For example, a current route of a user may be input to a model that may predict a destination within the environment. To reduce transactional friction, a coupon or other incentive may be sent to the user’s device, or the like. In another example, locations of certain products may be provided if it appears that the user is lost or looking for something. These incentives or informational notifications may be based not only on location, but also demographics and/or application data if available.

More specifically, the camera data and the beacon data may also be combined with app data. For example, a user may enter a retail environment and have an application on their device for that same retail environment. By collecting camera data and beacon data, information relative to a physical space (e.g., the environment 100) can be combined with information available on the device or, more specifically, made available in the application. This allows a profile to the user to be improved based on the user’s physical journey or route inside the physical environment. For example, products that the user appears to view, places in their cart, actually purchases, or the like can enhance the user’s profile for both offline and online experiences.

Embodiments of the invention may also be used for other purposes, such as security. Restricted spaces can be protected. When a user enters a restricted space, this is known from the route or current location of the user and/or the device. As a result, an alert may be generated on the user’s device or security can be alerted. The routes may be analyzed collectively to determine whether some routes are suggestive of certain actions (e.g., retail theft).

In one example, a depth camera (e.g., aStereoLabs ZED 2i) can provide distance and an angle of a detected user, which represent the location of the person relative to the camera. Embodiments of the invention can then represent an absolute location of the user in an environment at least because the location and/or orientation of the camera in the environment is known.

UWB is a radio technology that enables precise positioning and tracking. In some examples, accuracies with accuracies up to inches may allow devices to be identified and distinguished even when users are standing next to each other in an environment. In some examples, beacons may have omnidirectional antennas. In this case, determining a location of a user may require at least one other beacon.

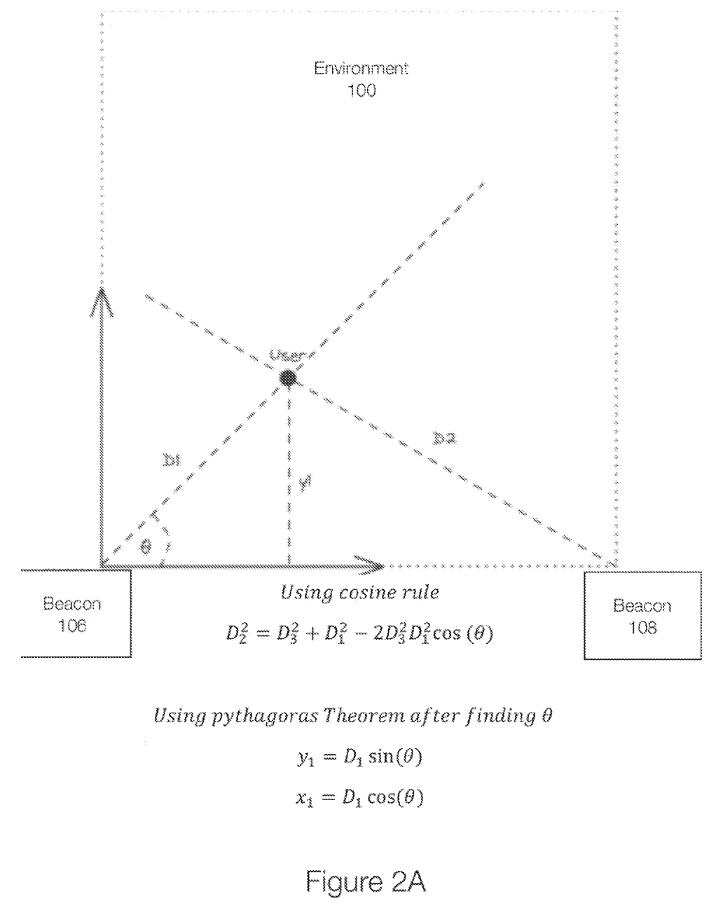

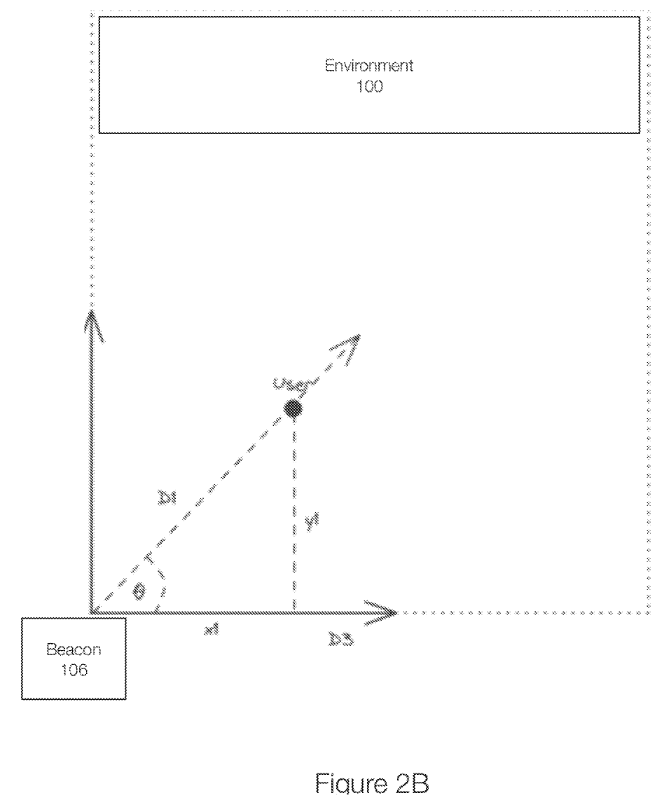

FIGS. 2A-2B disclose aspects of determining a location or a user/device in two-dimensional space. In one example, when the beacons 106 and 108 have omnidirectional antennas, the location (e.g., x and y positions) of a device in the environment can be determined using a cosine rule as illustrated in FIG. 2A using at least two beacons. The location of a device can be determined using a single beacon when the beacon has a directional antenna as illustrated in FIG. 2B.

More specifically in the example of FIG. 2A, the beacons 106 and 108 are omnidirectional and two beacons are used to determine a location of the user in the environment 100. In the example of FIG. 2B, the beacon 106 is directional and the location of the user can be determined from one beacon.

Routes of users/devices can be determined by combining multiple locations. In some examples, data may be collected according to a schedule, period (e.g., seconds or less), when triggered (e.g., camera data collected when UWB signal detected), or the like or combinations thereof.

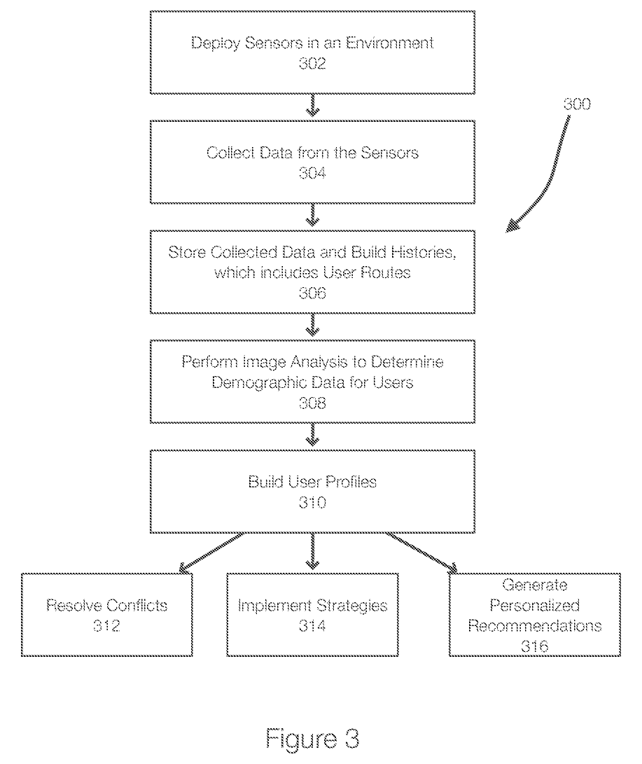

FIG. 3 discloses aspects of building user profiles based on data collected from a physical environment. Some aspects of a method 300 may be performed on an as needed basis, during initialization or setup, or the like. For example, the method 300 includes deploying 302 sensors (e.g., beacons, depth-cameras) in an environment. This may include calibrating the sensors such that locations are performed with respect to the same map or environment. In one example, the physical environment may be converted or represented as a 2D mapping and the sensors are configured to identify locations within the 2D mapping, which can be easily presented on a display.

Once the sensors are deployed an operating, data is collected 304 from the sensors. This data may be collected using messages generated by the sensors and transmitted to a computing system. The sensors may have some processing capabilities. For example, a beacon may determine a location and transmit the location. A camera may determine distance and angle, which can be converted to a location in the 2D mapping. The camera may include AI, which allows images to be transmitted as well if necessary when an object is classified by the camera’s AI as human. Alternatively, images may be transmitted and analyzed at a more powerful computing device.

The data is collected and stored and histories, which may include user routes, are built 306. Building the histories, or routes, may include matching device routes with user routes to generate a combined route, adding demographic data to routes or to combined routes, or the like. More specifically, once the routes are matched (histories are built), image analysis may be performed 308 to determine demographic data for users/devices associated with the combined routes.

User profiles are then built 310 based on the combined routes and the demographic data. The profiles may be stored and used for subsequent analysis. For example, the routes may indicate that many users spend time at and purchase products from a specific aisle or location. This information allows the retail strategy to be adapted (stock more of the same/similar/related product). Thus, the user profiles may be used to implement 314 strategies. Personalized recommendations may also be generated 316. If an application is available, the user profile can be integrated into the specific user’s profile, used in both online and/or offline scenarios, or the like.

In another example, the collected data may indicate a measurement error or other conflict. In this example, specific beacons or cameras or other sensors may be recalibrated to resolve conflicts 312.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, environment operations, user profile building operations, route related operations, data collection operations, cross pollinating operations for route building, location related operations, location determining operations, and the like. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the terms ‘object’ and ‘data’ are intended to be broad in scope. Example embodiments are applicable to any system capable of storing and handling various types of objects or data, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving data from sensors deployed in an environment at a computing system, the sensors including radio beacons and depth-cameras and the data including beacon data and camera data, building histories from the data, the histories including positions of users in the environment and positions of devices in the environment, wherein combined routes of the users are generated by combining at least the beacon data and the camera data, building a user profile for each of the users based on the histories, and generating personalized recommendations for each of the users based on corresponding user profiles, wherein the personalized recommendations are delivered to devices associated with the corresponding users.

Embodiment 2. The method of embodiment 1, wherein the at least some of the beacons and depth-cameras are configured in pairs.

Embodiment 3. The method of embodiment 1 and/or 2, wherein, for a pair of a radio beacon and a depth-camera, the depth-camera is activated when the radio beacon detects a signal from a device, wherein the pair share (x,y) coordinates in a two dimensional plane.

Embodiment 4. The method of embodiment 1, 2, and/or 3, wherein the beacon data determines device routes in the environment and the camera data determines user routes in the environment and demographics of the users, wherein the combined routes each include device routes that match user routes.

Embodiment 5. The method of embodiment 1, 2, 3, and/or 4, further comprising, for each of the combined routes, analyzing image data from the cameras to determine demographic data for the corresponding user, wherein the demographic data includes height, gender and age.

Embodiment 6. The method of embodiment 1, 2, 3, 4, and/or 5, wherein the depth-cameras are associated with a model configured to classify objects in image data as humans, wherein positions in the environment are determined for the users.

Embodiment 7. The method of embodiment 1, 2, 3, 4, 5, and/or 6, further comprising resolving conflict, which includes recalibrating at least some of the sensors.

Embodiment 8. The method of embodiment 1, 2, 3, 4, 5, 6, and/or 7, wherein the beacons are ultra-wide band beacons and are mounted at an anticipated height of user devices in the environment such that locations are determined using two-dimensional processing and wherein the depth-cameras are mounted higher than the beacons, wherein the beacons track positions of devices in the environment using ultra-wide band signals.

Embodiment 9. The method of embodiment 1, 2, 3, 4, 5, 6, 7, and/or 8, further comprising associating a user’s application on the user’s device with a corresponding user profile.

Embodiment 10. The method of embodiment 1, 2, 3, 4, 5, 6, 7, 8, and/or 9, further comprising performing a security operation when a user, based on a corresponding user profile, enters a restricted area.

Embodiment 11. A system configured to build user profiles, the system comprising: radio beacons mounted in an environment, wherein each of the radio beacons is mounted at a height corresponding to an anticipated height of user devices in the environment, wherein the radio beacons are configured to determine locations of the user devices in the environment, depth-cameras mounted in the environment at heights higher than the height at which the radio beacons are mounted, wherein the depth-cameras are configured to detect the users and determine locations and demographics of the users in the environment, and a computing system configured to receive messages from the radio beacons and messages from the depth-cameras, wherein the computing system compares device routes generated from the messages from the radio beacons with user routes generated from the messages from the depth-cameras to generate a combined route for each of the users, wherein the combined routes are included in corresponding user profiles, wherein the computing system is further configured to generate personalized recommendations for each of the users based at least on the user profiles.

Embodiment 12. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

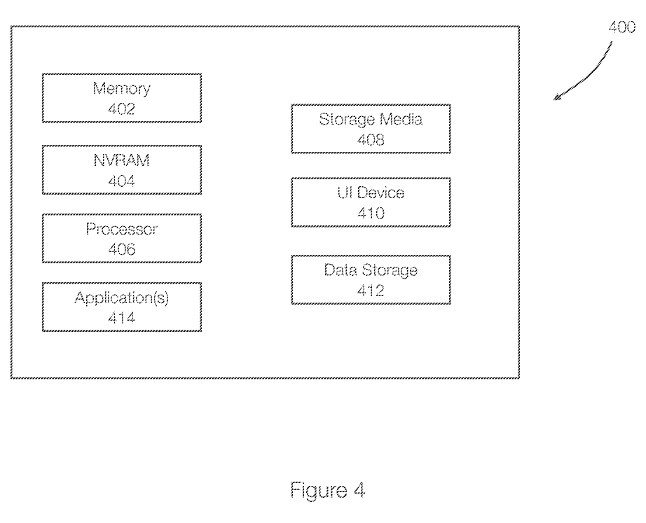

With reference briefly now to FIG. 4, any one or more of the entities disclosed, or implied, by the Figures, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
receiving data from sensors deployed in an environment at a computing system, the sensors including radio beacons and depth-cameras and the data including beacon data and camera data;
building histories from the data, the histories including positions of users in the environment and positions of devices in the environment, wherein combined routes of the users are generated by combining at least the beacon data and the camera data;
building a user profile for each of the users based on the histories; and
generating personalized recommendations for each of the users based on corresponding user profiles, wherein the personalized recommendations are delivered to devices associated with the corresponding users.

2. The method of claim 1, wherein the at least some of the beacons and depth-cameras are configured in pairs.

3. The method of claim 2, wherein, for a pair of a radio beacon and a depth-camera, the depth-camera is activated when the radio beacon detects a signal from a device, wherein the pair share (x,y) coordinates in a two dimensional plane.

4. The method of claim 1, wherein the beacon data determines device routes in the environment and the camera data determines user routes in the environment and demographics of the users, wherein the combined routes each include device routes that match user routes.

5. The method of claim 4, further comprising, for each of the combined routes, analyzing image data from the cameras to determine demographic data for the corresponding user, wherein the demographic data includes height, gender and age.

6. The method of claim 1, wherein the depth-cameras are associated with a model configured to classify objects in image data as humans, wherein positions in the environment are determined for the users.

7. The method of claim 1, further comprising resolving conflict, which includes recalibrating at least some of the sensors.

8. The method of claim 1, wherein the beacons are ultra-wide band beacons and are mounted at an anticipated height of user devices in the environment such that locations are determined using two-dimensional processing and wherein the depth-cameras are mounted higher than the beacons, wherein the beacons track positions of devices in the environment using ultra-wide band signals.

9. The method of claim 1, further comprising associating a user’s application on the user’s device with a corresponding user profile.

10. The method of claim 1, further comprising performing a security operation when a user, based on a corresponding user profile, enters a restricted area.

11. A non-transitory storage medium having stored therein instructions that are executable by one or more hardware processors to perform operations comprising:
receiving data from sensors deployed in an environment at a computing system, the sensors including radio beacons and depth-cameras and the data including beacon data and camera data;
building histories from the data, the histories including positions of users in the environment and positions of devices in the environment, wherein combined routes of the users are generated by combining at least the beacon data and the camera data;
building a user profile for each of the users based on the histories; and
generating personalized recommendations for each of the users based on corresponding user profiles, wherein the personalized recommendations are delivered to devices associated with the corresponding users.

12. The non-transitory storage medium of claim 11, wherein the at least some of the beacons and depth-cameras are configured in pairs, wherein, for a pair of a radio beacon and a depth-camera, the depth-camera is activated when the radio beacon detects a signal from a device, wherein the pair share identical (x,y) coordinates in a two dimensional plane.

13. The non-transitory storage medium of claim 11, wherein the beacon data determines device routes in the environment and the camera data determines user routes in the environment and demographics of the users, wherein the combined routes each include device routes that match user routes.

14. The non-transitory storage medium of claim 13, further comprising, for each of the combined routes, analyzing image data from the cameras to determine demographic data for the corresponding user, wherein the demographic data includes height, gender and age.

15. The non-transitory storage medium of claim 11, wherein the depth-cameras are associated with a model configured to classify objects in image data as humans, wherein positions in the environment are determined for the users.

16. The non-transitory storage medium of claim 11, further comprising resolving conflict, which includes recalibrating at least some of the sensors.

17. The non-transitory storage medium of claim 11, wherein the beacons are ultra-wide band beacons and are mounted at an anticipated height of user devices in the environment such that locations are determined using two-dimensional processing and wherein the depth-cameras are mounted higher than the beacons, wherein the beacons track positions of devices in the environment using ultra-wide band signals.

18. The non-transitory storage medium of claim 11, further comprising associating a user’s application on the user’s device with a corresponding user profile.

19. The method of claim 18, further comprising performing a security operation when a user, based on a corresponding user profile, enters a restricted area.

20. A system configured to build user profiles, the system comprising;
radio beacons mounted in an environment, wherein each of the radio beacons is mounted at a height corresponding to an anticipated height of user devices in the environment, wherein the radio beacons are configured to determine locations of the user devices in the environment;
depth-cameras mounted in the environment at heights higher than the height at which the radio beacons are mounted, wherein the depth-cameras are configured to detect the users and determine locations and demographics of the users in the environment;
a computing system configured to receive messages from the radio beacons and messages from the depth-cameras, wherein the computing system compares device routes generated from the messages from the radio beacons with user routes generated from the messages from the depth-cameras to generate a combined route for each of the users, wherein the combined routes are included in corresponding user profiles;
wherein the computing system is further configured to generate personalized recommendations for each of the users based at least on the user profiles.
